(19) United States
(12) Patent Application Publication
(10) Pub. No.: US 2006/0170769 A1
(43) Pub. Date: Aug. 3, 2006

(54) Human and object recognition in digital video

(76) Inventor: Jianpeng Zhou, Toronto (CA)

Correspondence Address: DEETH WILLIAMS WALL LLP, 150 YORK STREET, SUITE 400, TORONTO, M5H 3S5, CA

(21) Appl. No.: 11/342,805

(22) Filed: Jan. 31, 2006

Related U.S. Application Data
(60) Provisional application No. 60/647,770, filed on Jan. 31, 2005.

(51) Int. Cl. G06K 9/00; H04N 7/18

(52) U.S. Cl. 348/143; 382/103

(57) ABSTRACT

The current invention is a method or a computer implemented tool for robust, low CPU, low resolution human tracking which may be implemented a part of a digital video management and surveillance system or on a digital video recorder. The method involves use of intensity, texture and shadow filtering in the YUV color space to reduce the number of false objects detected. The thresholds for background segmentation may be dynamically adjusted to image intensity. The human and object recognition feature operates on an adaptive codebook based learning algorithm.

### TECHNICAL FIELD OF THE INVENTION

This invention is related to the field of automated digital video surveillance and monitoring system, and the automated acquisition, processing, classification and storage of digital video records.

### BACKGROUND OF THE INVENTION

Digital video surveillance and monitoring systems have wide spread use in security, inventory control and quality control applications.

Many current systems tend to separate the image processing and data recordal functions which can lead to an incomplete record, especially if video data is modified or lost before being processed. Those systems that perform real time analysis, which are generally preferred, tend to be limited to particular features only and do not provide a robust solution.

Prior Human & Object Tracking Procedures

With the increasing threat of terrorism, advanced video surveillance systems need to be able to analyze the behaviours of people in order to prevent potentially life-threatening situations. There are a variety of technological issues that are not adequately addressed by prior attempts to provide this functionality in real time, including: foreground segmentation and false alarm elimination. Current algorithms for foreground segmentation do not adequately adapt to environmental factors such as heavy shadows, sudden change in light, or secondary objects moving in what should be considered the background. While most human detection and tracking systems work fine in an environment where there is a gradual light change, they fail to handle situations where there is a sudden change in the light condition. An improved system should address these concerns.

Human and object tracking applications require comparatively large amounts of processing power making the feature very difficult to implement in either real time, or low cost applications. Typically, the video image undergoes 4 processes before any tracking process can be implemented. These first four steps are: (i) background segmentation, (ii) background subtraction to resolve the foreground image, (iii) noise filtering and (iv) foreground segmentation into regions of interests containing moving objects (the region of interest is commonly referred to as a “blob”). Prior art processes tend to use mixed Gaussian analysis in the background segmentation step, an analysis which is too computationally intensive to be operated continuously in real time using processors having speeds in the order of 2 GHz. Other practitioners have used a 1-Gaussian distribution coupled with size and morphologic filters to approximate the same performance as a mixed Gaussian analysis, but this practice tends to create problems in differentiating between shadows and new objects.

Occlusion is a significant problem in human tracking. Most previous work does not deal with occlusion at all. In order to solve the problem of occlusion.

### SUMMARY OF THE INVENTION

The invention provides variations and improvements on existing DVR configurations resulting in a automated human and object tracking on both live and recorded images, behaviour recognition and deviation flagging. The invention is capable of providing all of these features when operated on compressed images from a 2 phase 640 pixel by 240 pixel or higher resolution video signal, each processed image being 320 pixel by 240 pixel YUV.

The specification relies on a practical application of the notion “real time”, which implies in the case of continuous processes, that the queue to the process does not grow unbounded during operation, and that completion of any process is not delayed by more than a few seconds in the initialization phase with sufficiently shorter times once initialization is complete. Real time also implies that results or flags related to automated image processing can be posted with the video stream as the video stream is being displayed with little or negligible delay.

Human and Object Tracking

The human detection and tracking system disclosed herein has the ability to overcome the problems of foreground segmentation and false alarm reduction in real-time when integrated into a DVR.

The current invention addresses deficiencies in the prior art by implementing a shadow detection filter in the background segmentation stage of the human and object tracking process. The shadow filter performs an analysis of colour variation to normalize for colour change due to shadows, and performs edge detection to prevent false alarm shadow removal. One aspect of the invention combines a shadow filter, a size filter and a morphologic filter with a 1-Gaussian distribution analysis of the image, to achieve a background segmentation step with performance comparable to that of a mixed Gaussian analysis, but requiring far fewer computations of the mixed Gaussian analysis.

The steps in the human and object tracking process are background segmentation, subtraction of background image to reveal foreground image, noise filtering on foreground image, and blob detection. “Blob” is a term of art used to describe a foreground image segment representing an item of interest, which may be human, animal, or anything not resolved into the background. Once the blob has been created (i.e. once an item of interest detected), the invention may implement various video processing features adapted to perform using less processor power than existing designs. As one of the technical improvements of the current invention, a trained library of vectors relating to characteristic ratios in the blob can be used to identify whether the blob represents either a human or a non-human item. Human can be efficiently identified by automated measurement of similar ratios of an object moving within the video stream, and comparison of the measured ratios with the trained library of characteristic ratio vectors is an efficient implementation of the human identification feature. As a second improvement, a record of the positions of the blob through a series of frame in the video stream can be tracked without a further need for background segmentation on the entire image. As a third improvement, a vector based human recognition method is applied to a blob identified as human. The sub-image or blob containing an identified human can be further analysed by the DVR to perform automated human recognition based on a continually generated codebook of possible subject humans, whose characteristic ratio vectors have been recorded.

The analysis of the sub-image or blob, as opposed to the original video streams, saves processing power, so that the features of behaviour analysis, movement records, and tripwire alarm status can be operated simultaneously and in real time.

Where a non-human object is brought into the field of view, the DVR of a preferred embodiment of the current invention, with the features noted above, is capable of registering the object as non-human, setting a report flag. Vector analysis based on either pre-computed or trained code books can be used to identify such objects as well as to ascertain whether particular objects are permitted to remain within the field of view. A flag or alarm can be set to warn a human surveillance operator, for instance, that a new object has been left unattended in a hall way. The flag itself can be of any number of forms. A flag can be a computer controlled memory element with at least 2 states indicating the presence or absence of a particular condition measured by the system or set by a user, or perhaps a probability estimate of whether an event has occurred is preferred. The flag may only be a temporary signal transmitted within a computer circuitry with or without storage.

The importance of real time monitoring of such events is an important improvement of the current system over existing systems and has real economic value. The computation savings in the background segmentation step allow for loitering, theft, left baggage, unauthorized access, face recognition, human recognition, and unusual conduct to all be monitored automatically by the DVR in real time after the initialization phase performed on the image. In a preferred embodiment, the background segmentation phase is performed every 30 seconds for a static camera. Recalibrating the background image allows the processor to save time by not actively tracking stopped objects until they have begun to move again. The system is able to automatically determine whether objects or humans have been incorporated into the background, and an appropriate counter or flag is set related to the object or loiterer. Objects which should not become part of the moving foreground image can be flagged as stolen. The addition of the shadow filter reduces the number of false positives (false alarms) without unduly increasing the number of false negatives (missed detections). Since the DVR is a fully integrated solution, the results of each detected event can be programmed to automatically call for a live response.

The human object recognition and tracking system of the current invention also employs a recursive “learning” algorithm which allows the system to quickly reduce the number of false alarms triggered, without significantly impacting the number of false negatives. Model based human recognition analyzes the shape of an object and distinguishes people from other objects based on criteria discussed in greater detail below. In order to recognize human beings, a codebook of potential shapes is used to model the shape of a person. A distortion sensitive competitive learning algorithm is used to design the codebook. A pre-populated codebook may be used to initialize the system, and as the system operates in a given environment, the codebook is improved through operation.

### BRIEF DESCRIPTION OF THE DRAWINGS

FIG. 1 is a schematic of the software and hardware architecture for the digital video management system.

FIG. 2 is a flow chart describing the steps to implement human detection and tracking functionality within the DVR.

FIGS. 3A and B show the mask image of a human object and the boundary of the mask respectively.

FIG. 4 shows a method for selecting points on either side of a boundary.

FIG. 5A is a greyscale views of an image from a colour video test stream, and FIG. 5B is the result of performing the foreground background segmentation on the image. FIGS. 6, 7, 8, 9 and 10 are greyscale views of colour test images used to measure the efficiency of the human recognition algorithm of the current invention.

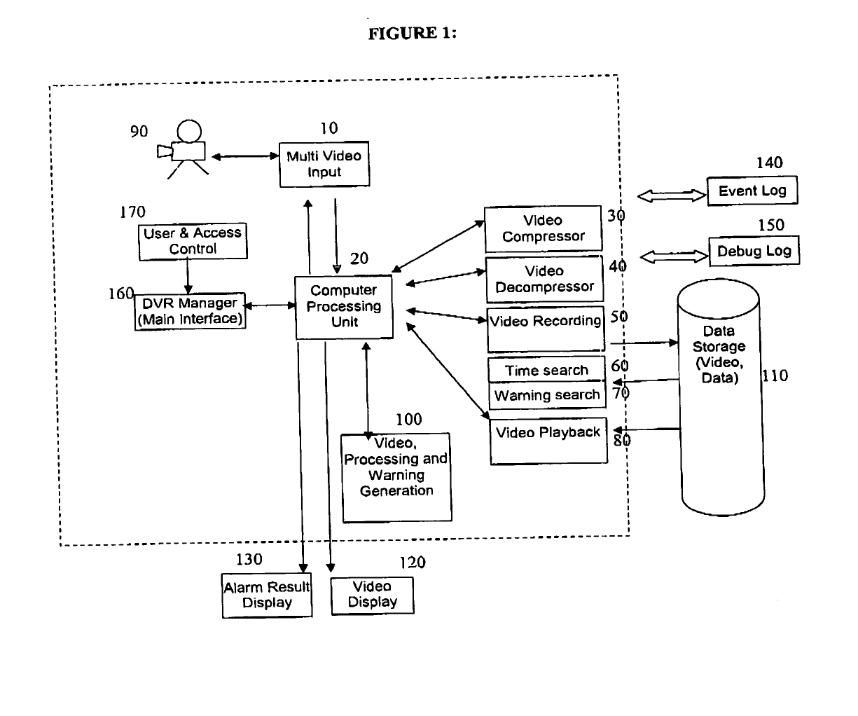

### DETAILED DESCRIPTION OF THE INVENTION

A detailed description of the embodiments of the invention is provided with specific reference to the drawings.

Primary surveillance input to the DVR is provided by a Multi Video Input 10. The Multi Video Input module 10, preferably provides digital video, but analog data may also be provided, in such instances where analog to digital converters are provided. A camera 90, is shown as a possible peripheral device capable of providing video and audio data. The camera 90, may be of any type capable of providing a stream of color video images in either the YUV color space or a color space easily converted to YUV. YUV allows the color information (Blue and Red) to be separated from the luminescent information of light. In most applications for which the system of this invention is designed, the maximum required resolution is only 640×240 2 phase video with 30 frames per second, optionally deployed with pan tilt zoom (PZT) controlled through the DVR. Other standards are also possible, with higher resolution cameras being usable, limited only by the bandwidth limit between the Multi Video Input module 10. Pursuant to another inventive aspect, a 3 mega pixel or 5 mega pixel camera may emulate the PZT functionality through image cropping and compression.

The Multi-video input module thread communicates the arrival of data to the Computer Processing Unit 20. The Multi-video input module thread also includes control functionality to allow the Computer Processing Unit 20, to post messages which include control instructions for the operation of individual peripheral devices.

The Video Compressor Module 30, may be called to perform video compression on a data record for various purposes, including display, analysis or recording. The Video Decompression Module 40, may be called by the Computer Processing Unit 20, to decompress compressed images.

The Video Recording Module 50, may be called by the Computer Processing Unit 20, to store such data (in either compressed, non-compressed or modified form) in the Data Storage 110. The Time Search Module, 60, and the Warning Search Module, 70, are able to search for Video, Audio and Sensor information containing in the Data Storage, 110, based on the time or warning flags, respectively, also stored in the Data Storage, 110.

The Video Playback Module 80, retrieves video segments for transmission to the Video Display 120. The Video Playback Module 80, provides the media control messages, such as; PLAY, NEXT, BACK, REWIND, FORWARD, STOP, etc. This module keeps a point to the current frame. Various mechanisms known to person of skill in the art can be implemented at modules to allow for specialized playback features, such as continual playback.

Typical User Access Controls 170, may include standard PC style Input Output (I/O) devices included as part of the DVR. The I/O devices interface with a DVR Manager (main interface) 160, which acts as a control block between actual operators and the Computer Processing Unit module 20.

The present invention discloses improved video analysis methods for human/object recognition and differentiation. It performs faster background segmentation without substantial loss of reliability by using a preferred model for shadows (as discussed in greater detail below) and also better accounts for occlusion of humans within the frame. This robust, real-time human recognition and differentiation from objects method enables a more robust and human detection and tracking system for video surveillance, which can be used in varying environments. This solution helps users monitor and protect high pedestrian areas. This pseudo-intelligent software identifies regions of video images and recognizes as either human or inanimate objects based on the implementation of a learning algorithm. Suspicious human actions such as entering into a restricted zone, changing direction, or loitering are determined on the basis of human recognition and tracking through the video data. Such events are recorded and reported based on automated rules within the software. By differentiating humans from objects within the field of view, the overall resource expenditure on human tracking can be reduced. Other systems without this capability must examine the motion of all objects within the field of view. Unlike other less robust systems, the system and method of the current invention requires less human intervention to provide pedestrian zone surveillance.

One goal of the tracking functionality used to implement the Human/Object Recognition module, is to establish a correspondence between people in a video current frame and the people in the previous frame, and to use this as a basis for determining what every individual is doing. In order to track people, people must first be distinguished within the frame, and so a human model is generated. The human model includes human features such as color, aspect ratio, edge, velocity etc. Occlusion is a significant problem in human tracking. Many earlier DVR systems with human tracking algorithms do not address occlusion at all. In order to solve the problem of occlusion, a preferred embodiment of the current invention combines a Kalman filter based method with an appearance-based tracking method. The appearance parameters may be stored in an adaptable library containing a color histogram based model of human features.

Most algorithms developed in previous works were based on red-green-blue (RGB) color space. Since data may be obtained using a [define] (YUV), the prior art would imply a need to convert such images from a YUV color space to a RGB space. Such a mapping substantially increases the burden on the CPU. To overcome this problem, the system and method of the immediate invention models human colour characteristics directly in the colour space of the input data. In the instance where colour images are supplied in the YUV color space, the immediate system creates substantial savings in CPU processing time over previous systems.

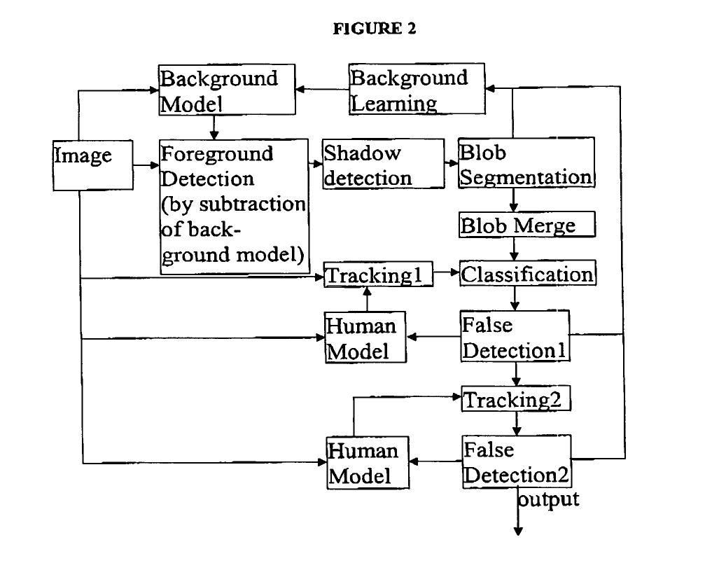

As shown in FIG. 2, the human detection and tracking system and method of the immediate invention consists of the following parts: image collection; foreground detection; shadow detection; blob segmentation; background modeling (learning); human modelling for human recognition; human modeling for tracking and false object detection in each of the recognition and tracking stages. A background subtraction approach is used for foreground detection. Since this is an iterative process, there is a start up cost of CPU time which diminishes over the course of processing a video stream with constant camera parameters. After the background subtraction, shadow detection is applied. In order to filter out the camera noise and irregular object motion, the immediate invention uses morphological operations following the shadow detection. By this recursive process, the foreground mask image is formed. If motion has been detected within the frame, “blobs” representing the region of the image containing the moving object are segmented from the foreground mask image. Because of noise and occlusion, one object may include several blobs. For this reason, the immediate invention imposes an additional step, “blob merge”, to simulate a whole object. The blob merge step is a software implemented video processing tool applied immediately following the blob segmentation step.

The immediate invention performs human/object recognition and classification by assuming that all blobs must be tracked, and then characterizing them on the basis of the following rules: (i) the blob is capable of being tracked and is an object and presumably human; and (ii) an adaptable codebook recognizes whether or not the blob is human. These two rules also from the basis of two false object detection tests used to reduce the false alarms and to adjust the background model, as shown in the architecture flow chart of FIG. 2.

Background subtraction is used to provide a foreground image through the threshold of differences between the current image and reference image. If the reference image is the previous frame, the method is called temporal differencing. Temporal differencing is very adaptive to a dynamic environment, but generally does a poor job of extracting all relevant feature pixels. A combination of Gaussian, Nonparametric Kernel, and codebook can result in better performance, but they need extra expensive computation and more memory. For the real time system and method of the immediate invention integrated with a DVR system, a running average is sometimes used as a background model for a given set of camera parameters. Equations (1) and (2) are used to statistically analyse each pixel, P, between the n^{th} and n+1^{th} frames. This method allows the system to adapt to gradual light change and change of shadow position as light source and intensity changes.
μₙ₊₁=αμₙ+(1−α)Pₙ₊₁ (1)
σₙ₊₁=ασₙ+(1−α)|μₙ₊₁−Pₙ₊₁| (2)

where μₙ is a running average, σₙ is a standard deviation, Pₙ is pixel ivalue, α is updating rate in the n^{th} frame.

In order to filter out some noise caused by such factors as camera movement, water wave and tree leaves shaking, a new modified method of creating the difference image between the current image and the background image may also be employed. The method of using only equations (1) and (2) does not successfully deal with such environmental situations. A software tool executing the following steps obtains a more robust difference image to define the background. While the following discussion is in relation to pixels, the method generalizes to regions of the images which may be pixel, or may be groups of pixels compressed to a pixel, or any number of regions for which colour and intensity can be adequately defined.

The systems begins by defining Bₙ as a pixel in background image, with Bₙ¹, Bₙ², Bₙ³, Bₙ⁴ as its neighbours in the vertical and horizontal directions. Pₙ is the corresponding pixel of Bₙ in current image, and Pₙ¹, Pₙ² are its neighbours in the vertical direction. Then, the software tool computes the intensity histogram of pixels in the window r×r centered by Bₙ, and selects as Mₙ the maximum intensity value within the window r×r. in a preferred embodiment, r=7, and so pixels 3 spaces left, right, up or down within the window affect the maximum intensity value for Bₙ. The tool also calculates the median value \hat{P}ₙ of intensity values of Pₙ, Pₙ¹, Pₙ²; and calculates the mean value \overline{B}ₙ of intensity values of Bₙ¹, Bₙ², Bₙ³, Bₙ⁴. Finally, the difference value Dₙ can be computed according to the equation (3) based on assumption that water wave and tree shaking are the movement of the part of background.
Dₙ=min(|\acute{P}ₙ−Mₙ|,|\hat{P}ₙ−\overline{B}ₙ|,|\hat{p}ₙ−Bₙ^{Y}|) (3)

where |a| is the function of computing the absolute value of a, Bₙ^{Y} is the intensity value of Bₙ.

A foreground mask image MSK, of values MSKₙ corresponding to a true false test of whether the pixels Pₙ are in the foreground image, is created using equation (3) and the following rule. For system defined shadow threshold values, TH₁ and TH₂, TH₂, greater than TH₁; if Dₙ<TH₁, then MSKₙ=0; if Dₙ>=TH₂, then MSKₙ=1; is between TH₁ and TH₂, the tool performs a secondary test to check whether the difference in Pₙ is due to shadow. If Pₙ is shadow, MSKₙ=0, otherwise MSKₙ=1.

The selection of TH₁ is the key for successful threshold of the difference image. If TH₁ is too low, some background are falsely labelled as foreground and processor resources are wasted. If TH₁ is too high, some foreground are labelled background and the potentially useful information in the frame is ignored. Prior development suggests that 3σ should be selected as TH₁, based on the assumption that illumination gradually changes. However when light suddenly changes, this assumption will be violated. To assist in defining a dynamic threshold the tool computes the median intensity value of all pixels of an image of interest, MID, as a basis for determining an appropriate TH₁. In a preferred embodiment of the immediate invention, the tool dynamically selects TH₁ according to the level of light change, by searching the MID of the difference image and using equation (4) to compute TH₁ for each pixel, or as needed.
TH₁=MID +2σ+TD (4)

where TD is some initial threshold normally between 0 and 10, but set as TD=5 in the most preferred embodiment.

The other boundary, TH₂ can be selected as TH₁+Gat, where Gat is a gate. Since the gate determines whether the shadow level test is needed, it can be tailored to the shadow level test used. However, it may also be fixed to a value which provides a high degree of confidence that actual movement has occurred within the video frame. A preferred value for the latter configuration occurs when Gat is equal to 50, where Gat is measured in the grey level or intensity scale.

In order to adapt to a sudden light change, the tool may operate at different settings for α depending on the level of light change. In such an embodiment, the rate α could be selected as follows:

$$α = \{ \begin{matrix}{α}_{1} & if MID < {T}_{1} \\ {α}_{2} & if {T}_{1} \leq MID < {T}_{2} \\ {α}_{3} & others\end{matrix} \qquad ( 5 )$$

where T₁<T₂ are thresholds on the median value MID of the difference image. In a preferred embodiment, the values are fixed as α₁=0.9, T₁=4; α₂=0.85, T₂=7; α₃=0.8.

Shadow affects the performance of foreground detection in that regions falling under or coming out of shadow will be detected as foreground. The ability to effectively recognize shadow is a difficult technical challenge. Some previous work attempts to address the problem, by relying on the assumption that the regions of shadow are semi-transparent. The premise being that an area cast into shadow often results in a significant change in intensity without much change in chromaticity. However, no prior systems have implemented this approach in the YUV colour space.

In order to utilize the color invariant feature of shadow, a preferred embodiment of the present invention should use the normalized color components in YUV colour space, which are defined as U*=U|Y, V*=V|Y. Within this metric, the preferred shadow detection algorithm is performed as follows.

Step 1 is to compute the color difference. The tool computes bUₙ*, bVₙ* as the normalized color components of Bₙ, and cUₙ* , cVₙ* as the normalized color components of Pₙ. The color difference is defined as equation (6).
diff_{c}=|cUₙ*−bUₙ*|+|cVₙ*−bVₙ*| (6)

Step 2 is to compute the texture difference. The tool computes (or recalls) Bₙ^{Y} as the intensity value of Bₙ in background image, and Bₙ^{Y1}, Bₙ^{Y2}, Bₙ^{Y3}, Bₙ^{Y4} as the intensity values of pixels of its neighbours Bₙ¹, Bₙ², Bₙ³, Bₙ⁴ on the vertical and horizontal direction. Similarly, Pₙ^{y} is the intensity value of Pₙ pixel in current image, and Pₙ^{Y1}, Pₙ^{Y2}, Pₙ^{Y3}, Pₙ^{Y4} are the intensity values of pixels of its neighbors Pₙ¹, Pₙ², Pₙ³ and Pₙ⁴ on the vertical and horizontal direction. The pixels Pₙ, Pₙ¹, Pₙ², Pₙ³ and Pₙ⁴ define a shadow filter neighbourhood of the region of interest Pₙ in the current image. The pixels Bₙ, Bₙ¹, Bₙ², Bₙ³ and Bₙ⁴ define a corresponding shadow filter neighbourhood in the reference image. The texture difference is defined as equation (7).

$${diff}_{t} = {\sum }_{i = 1}^{4} \vert Th ( \vert {P}_{n}^{Y} - {P}_{n}^{Y 1} \vert ) - Th ( \vert {B}_{n}^{Y} - {B}_{n}^{Y 1} \vert ) \vert \qquad ( 7 )$$

Where Th(Val) is a function defined as equation (8).

$$Th ( Val ) = \{ \begin{matrix}1 & if Val > Th \\ 0 & others\end{matrix} \qquad ( 8 )$$

Step 3 employs the colour and texture differences to make a decision on whether or not shadow accounts for the difference between expected background pixel Bₙ and actual current pixel Pₙ. If diffₜ=0 and diff_{c}<cTh and Pₙ<Bₙ, then Pₙ is shadow, otherwise Pₙ is not shadow, where cTh is the color threshold. The assumption for Pₙ<Bₙ is that the region of shadow is always darker than background.

A functional goal of a digital video surveillance system is to be able to identify people and discern what each of them is doing without ongoing operator interaction. An optional module to achieve such a functional goal can be implemented using the system and method of the immediate invention.

To recognize humans, they must be separated from the background and distinguished from other objects. The software module uses a codebook to classify each human person as distinct from other objects. To simplify the process, the codebook is created based on a normalized object size within the field of view- Preferably, the normalized size of an object is 20 by 40. Each blob is scaled to the normalized pixel size (either notionally enlarged or reduced) and then the shape, colour etc, of features of the normalized blob are extracted. Once extracted, the extracted feature vector of the blob is compared with the code vectors of the codebook. The match process is to find the code vector in the codebook with the minimum distortion to the feature vector of the blob. If the minimum distortion is less than a threshold, the blob is classified as the object in the codebook corresponding to the code vector from which it had minimum distortion. A person of skill in the art would appreciate that there are many known ways to measure differences between vectors, and any of them could be used without loss of generality by selecting the appropriate threshold.

To better illustrate the procedure of classification based on a codebook, in a preferred embodiment the system is implemented as a software tool in which Wᵢ is the i^{th} code vector in the codebook. The software tool computes a feature vector X of a blob in the foreground image, or some other object identified within a video image. At any one time, N is the number of code vectors in the codebook. The dimension of code vector is M. In this example, the distortion between Wᵢ and X is computed as equation (9).

$${dist}_{i} = ‖ {W}_{i} - X ‖ = {\sum }_{j = 0}^{M} \vert {W}_{i}^{j} - {X}^{j} \vert \qquad ( 9 )$$

The minimum distortion between X and the code vectors in the code book is defined as equation (10).
diss=min(distᵢ) i=0, . . . , N−1 (10)

If diss is less than a threshold, the object with the feature vector X is an object classified within the codebook, otherwise, it is not. If the codebook is adapted to humans only, the object is a human or not.

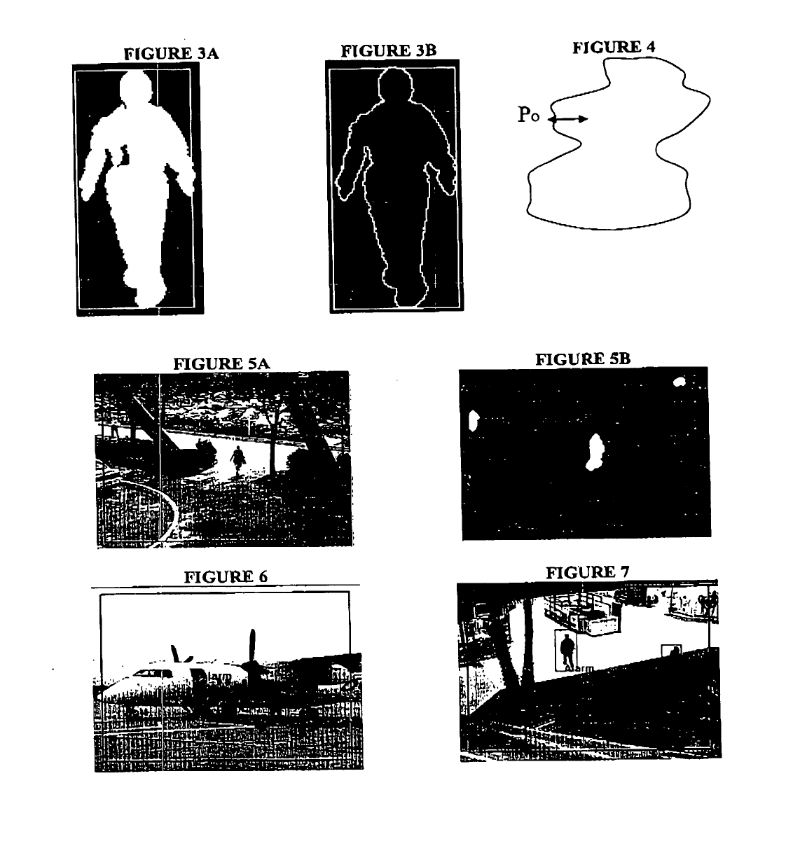

In order to create the shape vector of an object, the mask image and boundary of a human body are created as shown in FIG. 3a and b respectively. In the embodiment shown, the distance from the boundary of the human body to the left side of bounding box is used to create the feature vector for this blob. FIG. 3a is the mask image of human body and FIG. 3b is the boundary of human body To create a fast algorithm that does not need to examine every pixel, the implementation may select 10 points in the left side of the boundary, and compute their distances to left side of bounding box and take 10 points in the right side of boundary, and compute their distance to left side of bounding box. In some sense this creates a shape vector with a 20 entries. Such a vector of shape within a normalized blob, would be applied to a codebook based on the same characteristic measurements from other images already identified as human. Such a codebook could be updated.

The design of the codebook is critical for classification. The well-known partial distortion theorem for codebook design is that each partition region makes an equal contribution to the distortion for an optimal quantizer with sufficiently large number N of codewords. Based on this theorem, the human recognition codebook proposed in the current invention is based on a distortion sensitive competitive learning (DSCL) algorithm.

This description of one possible embodiment helps to illustrate the codebook design. In the embodiment, W={Wₗ;i=1, 2, . . . ,N} is the codebook and Wᵢ is the i^{th} code vector. Xₗ is the i^{th} train vector and M is the number of train vectors. Dₗ is the partial distortion of region Rₗ, and D is the average distortion of codebook. The DSCL algorithm can be implemented as a computer implemented tool using these parameters is as follows.

Step 1: Initialization 1:
Set W(0)={Wᵢ(0);i=1, 2, . . . ,N} and Dᵢ(0)=∞,Dᵢ(0)=1,j=0.

Step 2: Initialization 2

Set t=0

Step 3: Compute the distortion for each code vector
disᵢ=∥Xₜ=Wₗ(t)∥

Step 4: Select the winner: the k^{th} code vector.
dis_{k*=min(}Dₗ(t)disₗ) i=1, 2, . . . , N

Step 5: Adjust the code vector for winner
Wₖ(t+1)=Wₖ(t)+εₖ(t)(Xₜ−Wₖ(t))

Step 6: Adjust Dₖ for winner

$$Δ {D}_{k} = \frac{{N}_{k}}{t + 1} ‖ {W}_{k} ( t ) - {W}_{h} ( t + 1 ) ‖ + \frac{1}{t} {dis}_{k} {D}_{k} ( t + 1 ) = {D}_{k} ( t ) + Δ {D}_{k}$$

Where Nₖ is the number of train vectors belonging to region Rₖ.

Step 7: Check whether t<M

If l<M then t=l+1, and go to step 3. Others go to step 8.

Step 8: Compute D(j+1)

$$D ( j + 1 ) = \frac{1}{M} \sum ‖ {X}_{i} - W ‖$$

$$If \frac{\vert D ( j + 1 ) - D ( j ) \vert}{D ( j )} < ɛ stop , else j = j + 1 , then go step 2.$$

In one preferred embodiment of the system and method of the immediate invention, blob tracking can also be used for human classification. When the blobs in the current frame have been segmented, tracking them using the blobs in the previous frame is possible. If the blob is successfully tracked, then it can be classified as human. Otherwise, the preferred tracking tool uses the code book to recognize it.

In order to track individuals, the human model must be created for each individual. A good human model should be invariant to rotation, translation and changes in scale, and should be robust to partial occlusion, deformation and light change. The preferred model of the immediate invention uses at least the following parameters to describe humans: color histogram, direction, velocity, number of pixels and characteristic ratios of human dimension. In order to decrease the computation cost, the color of a pixel is defined using equation (11) as:
Iₙ=0.3Pₙ+0.35Uₙ+0.35Vₙ (11)

where Pₙ, Uₙ, Vₙ are the Y, U, V values of a pixel in the current image, and Iₙ is the color value used to compute the histogram. The model defines Hₗ and H_{ref} as the current histogram and reference histogram, which allows a comparison rule for histogram to be provided as equation (12).

$${H}_{s} = \frac{{\sum }_{i = 0}^{255} min ( {H}_{t} ( i ) , {H}_{ref} ( i ) )}{min ( {N}_{H}^{r} , {N}_{H}^{ref} )} \qquad ( 12 )$$

where N_{H}^{l}and N_{H}^{ref} are defined as follows;

$${N}_{H}^{i} {\sum }_{i = 0}^{255} {H}_{t} ( i ) , {N}_{H}^{ref} = {\sum }_{i = 0}^{255} {H}_{t}^{ref} ( i ) \qquad ( 13 )$$

For tracking, on a frame by frame basis, the assumption that a human target moves with only a small inter frame change in direction or velocity does not introduce much error. During the process of tracking, the preferred computer implemented tracking tool checks whether the person stops or changes direction. If the person doesn't move for period of time, the preferred computer implemented tracking tool may recheck whether the identification of the blob as a person was false. False positive identifications of persons or objects are thereby recognized by the system, which may then incorporate the information for future false alarm assessments and/or may adjust the background accordingly.

As shown in FIG. 2, there are two levels of tracking: blob level tracking and human level tracking. One purpose of blob level tracking is to identify moving objects that may then be classified as either human or non-human The goal of human level tracking is for analysis of human activity and further false positive human testing. The match condition of blob level tracking may be stricter than that of human level tracking.

It has been shown, that the system of the current invention is able to detect false objects caused by sudden changes in light, previously stationary humans of the background becoming foreground and shaking background objects. During blob tracking level, the system may identify false blobs caused by objects that have been dropped or removed or changes in light. By correctly identifying the event, the system is able to save resources by quickly incorporating the object into the background. Optionally, the system may also make a record of the event. A consideration in the decision of whether or not to push an object into the background may be the length of time it is stationary.

Conversely, the methods of false human detection may be able to heal the background image by selectively adding uninteresting, stationary foreground objects to it. In some aspects of the invention, false object and human detection is performed during the process of tracking as shown in FIG. 2. During human tracking level, the system may identify blobs caused by a tree shaking, occlusions, merging of groups, the human otherwise interacting with previously background objects. Some identified objects, like a shaking tree, or a slightly moved chair, should be quickly identified as false objects and reincorporated into the background. With this kind of false object, the human can not be successfully tracked in similar direction. It may also be preferable in a system of the current invention, that when a person moves in some limited area of the image for an adaptable period of time, the person may rightly be incorporated into the background by being notionally declared false. The system is able to recognize the person again, once the person begins to move outside the limited area.

During blob tracking, the system may be permitted to make the assumption for the purposes of detection that object boundaries coincide with color boundaries. The following steps are used to detect the false blob.

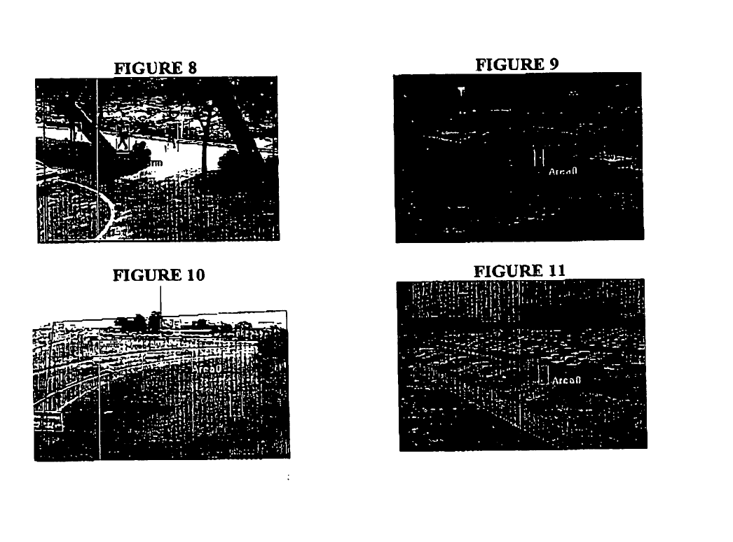

Step 1: use the foreground mask image to create the boundary of blob. For every pixel in boundary, find two points Po and Pi outside and inside boundary respectively. Po and Pi have the same distance to the boundary. This is illustrated in FIG. 4.

Step 2: The computer implemented tool determines N_{b} as the number of pixels on the boundary of the blob at issue, and computes the gradient feature G_{c} of the boundary in the current image and the gradient feature G_{b} of similar points in the background image. The gradient feature G of the boundary is calculated using the equation (14).

$$G = {\sum }_{j = 1}^{{N}_{b}} Grad ( \vert {Po}^{j} - {Pi}^{j} \vert ) \qquad ( 14 )$$

where Po^{j}, Pi^{j} are the pixel values of the outside and inside points chosen with respect to the jth point of boundary of the blob, respectively. The Function Grad(Val) is defined as follows:

$$Grad ( Val ) = \{ \begin{matrix}1 & if Val > GTh \\ 0 & others\end{matrix} \qquad ( 15 )$$

where GTh is a predetermined gradient threshold selected by the operator.

Step 3: The computer implemented tool makes the decision, if G_{c}>1.2G_{b} or G_{c}<0.3N_{b}, then this blob is false. The ratios 1.2, and 0.3 are preferred ratios for the digital images collected by the system of the immediate invention. A skilled user will understand that different ratios may be preferred for different image standards.

During human tracking, the system may be permitted to make the assumption for the purposes of detection that false objects are caused by movement of a part of background, like the tree branch shaking or a slightly moved object (door, chair, papers, litter, etc.). The detection algorithm is described as follows.

Step 1: The computer implemented tool creates and analyzes a colour histogram of each object to determine a colour characteristic for the pixels of the object. Often, false objects will have a similar colour scheme as compared to humans, which tend to display more variety of colour. In cases where a false object has been detected in a particular area, the pixel values of the background image can be configured based on the colour having the maximum probability in the color histogram for such false object.

Step 2: The computer implemented tool uses the colour having the maximum probability in the color histogram as a seed value to determine whether a change in pixels of the current image Is due to re-orientation of a background object. If the number of pixels covered by an extended region is more than the number of original object, then the object may not be new, but merely re-oriented.

The human and object detection and tracking system of the present invention may be configured as a real-time robust human detection and tracking system capable of adapting its parameters for robust performance in a variety of different environments, or in a continually varying environment.

The background subtraction technique has been tested against environment challenges such as a moving camera, shadow and shaking tree branch to segment the foreground. The algorithm used has been proven robust in varying environments. During the process of human recognition, an adaptive codebook is used to recognize the human form. In order to reduce the occurrence of false alarms, the system employs new and useful algorithms to identify false alarms. This experimentation also confirms that this tracking algorithm, based on the color histogram, is robust to partial occlusion of people.

The performance of the background subtraction algorithm is shown in FIGS. 5a and 5b. FIG. 5a shows a greyscale view of a current colour video Image frame featuring a shaking tree, heavy shadows and two people. FIG. 5a shows a background image mask in which the people are correctly identified as foreground and only one shaking branch is identified as foreground but as a non-human object.

After training the system using video streams of 10 people moving randomly in front of a camera attached to the digital video management system of the current invention, the system was used indoors and outdoors to test the performance of human classification module. The test results indicated that more than 99% of the humans were correctly classified if they were not far from the camera. Although vehicles on the street were never classified as human, some chairs were falsely classified as human. FIGS. 6 and 7 show greyscale views of colour images in which the human classification module of the immediate invention is able to identify humans (as shown by the rectangular boxes around them. The large rectangular box inside the edge of the image shows the region of the image being examined.

TABLE 1
Accuracy of human classification module without operator intervention

| | Area | Crosswire | Idle | |
|---|---|---|---|---|
| Camera | alarm | Alarm | Alarm | Counter |
| Angle | 98% | 98% | 98% | 98% |
| Above | 93% | 90% | 92% | 85% |
| Far away | 95% | 92% | 95% | 93% |

Table 1 shows the accuracy of the human classification module at performing the various tasks indicated in real time using an input video stream, the background substraction methods of the current invention. The test performed in various environments, examples of which are shown in FIGS. 8, 9, 10 and 11. FIG. 8 shows a tested image in an environment where there was sudden change in light and a shaking tree branch. FIG. 9 shows a tested image in an environment with low light, in which background and foreground are fairly dark; but the person walking on the road was still detected. FIG. 10 shows a tested image in an location beside a highway, in which the vehicles moving on the highway are not detected as human, the shaking tree is not detected as human, but the person walking is correctly identified. FIG. 11 shows a tested image in a snowy environment.

The test demonstrates that the proposed computer implemented human classification module is robust. The test used a computer with P4 3.0 GHz and 512 MB memory to test the CPU usage for 4 channels. The 4 input video images were interleaved 320×240 pixel images at 30 frames per second. The test analyzed the alternating 15 frames per second captured by the DVR system, and CPU usage at the control process was less than 50%.

For display purposes, in one preferred embodiment of the invention, the rectangular pixel area or region used to identify and recognize a blob is shown on the video output monitors connected to the system so that a human operator can appreciate that an event has occurred and an object has been identified. The software can recognize the single person and a group of people, and segment the individuals from a group of people by recognizing the head, size and color of clothes the people wear. The software will create a model for each person at the moment the person is detected, then when the person moves, the software will track his trace of movement including the new location, moving step and moving direction, and predict where to go next step.

Where the method of the current invention is implemented as a neural network, the software has the basic ability to learn whether a particular type of motion is expected, and classify this as a false alarm. Sudden changes in light or environmental factors maybe filtered out using separate environmental readings, or by using environmental readings inferable from the video image itself. The longer the software runs, the more accurate its automated assessment of the field of view becomes.

The software can work in under a variety of environmental factors such as rain, clouds, winds and strong sunlight so on. The software uses the different filters to filter out different noises in different environment. The software can deal with shadow, tree shaking and so on.

The software has a very low false alarm rate and a high level of object detection because of the filter, the ability to adaptively model the background and the ability to adaptively recognize recurring false alarms. In an environment consisting of a smooth light change, low wind strength and little tree branch shaking, there is no false alarm.

In addition to the codebook to recognize humans, a codebook can also be generated to recognize vehicles, and have vehicles recognized as distinct from humans and other objects.

Once the detection tool has found a target to track, various behaviour analysis tools can be implemented in relation to identified moving blobs. This intelligent automated analysis can be used to trigger alerts without the need for human operator monitoring. In the field of digital video management systems, the primary concern is security, and so the current invention defines improved alerts and counters optionally implemented after human or object detection has occurred: (i) determine the number of objects in the area of interest; (ii) determine lack of movement of objects that should be moving; (iii) determine whether an object has crossed a threshold in the area of interest; (iv) determine how many objects have passed a threshold; (v) determine whether an object is moving in an improper direction, or against the flow of normal traffic; (vi) determine whether an object that should remain at rest is suddenly moved; and (vii) determine whether a person and an object have become separated in transit

The following alarms are optional implementations of the foregoing:

Intelli-Count™

When a group of people enter the area of interest, each individual will be recognized, if the number of persons in the area satisfies the preset condition, the alert will be set.

LOM Alert™

When a group of people enter the area of interest, and one or more of them stays longer than preset period of time, the alert will be set.

Crosswire Alert™

When an individual goes through a perimeter in a particular direction, the alert will be set.

Intelli-Track Count™

When a group of people enter through a preset gate, the software will count the number of people who enter in a specified direction.

Directional Alert™

Where a group of people go in a predicted direction and one person or several people go in the opposite direction, the software will detect these people and trigger alarm.

Theft Detection™

If some objects move in the area of interest, the software will detect them and set an alert.

Baggage Drop Alert™

If somebody drops a baggage inside the area of interest, the software will detect them and set an alert.

It will be appreciated that the above description relates to the preferred embodiments by way of example only. Many variations in the apparatus and methods of the invention will be clear to those knowledgeable in the field, and such variations are within the scope of the invention as described and claimed, whether or not expressly described. It is clear to a person knowledgeable in the field that alternatives to these arrangements exist and these arrangements are included in this invention.

1. A human and object recognition and tracking video image processing tool comprising the computer implemented steps of:
(a) obtaining a stream of color video images in the YUV color space;
(b) comparing a current video image in the stream to a reference image generated as a background model from past video images in the stream;
(c) determining a foreground image by using a mask to ignore each current region from the current video image which satisfies any of the following tests in relation to correspondingly positioned regions of the reference image:
(i) an intensity difference value generated from a neighbourhood of the current region and neighbourhoods of the corresponding region of the reference image is less than a first threshold; or
(ii) the intensity difference is between the first threshold and a second threshold, a texture difference generated from a shadow filter neighbourhood of the current region and a shadow filter neighbourhood of the corresponding region of the reference image is zero, a color difference generated from a shadow filter neighbourhood of the current region and a shadow filter neighbourhood of the corresponding region of the reference image is less than a color difference threshold, and the current region is darker than the corresponding region of the reference image.

2. The human and object recognition and tracking video image processing tool of claim 1 further comprising the steps of
(d) filtering the foreground image for noise;
(e) separating the foreground image into blobs and generating a feature vector for each blob;
(f) computing a vector difference between each feature vector to a codebook of code vectors, to determine a closest match code vector;
(g) recognizing the blob as the closest match code vector if the vector difference is less than a match threshold.

3. The human and object recognition and tracking video image processing tool of claim 2 further comprising the steps of
(h) tracking each blob which has been recognized between images of the stream without further background segmentation.

4. The human and object tracking video image processing tool of claim 1 in which the background model is generated using the current video image as a running average.

5. The human and object tracking video image processing tool of claim 1 in which the regions are pixels and the intensity difference is generated using a maximum intensity value of a window of 7×7 pixels centered on the corresponding region of the reference image.

6. The human and object tracking video image processing tool of claim 1 in which the first threshold is varied depending on a measure of the change in intensity between prior images and the current image.

7. The human and object tracking video image processing tool of claim 1 in which the stream of color video images is obtained from a camera having a resolution between 3 mega pixels and 8 mega pixels, and in which images may be compressed prior to processing.

8. The human and object recognition and tracking video image processing tool of claim 2 further comprising the step of setting an alarm flag if a number of humans recognized in the stream satisfies a preset alarm condition.

9. The human and object recognition and tracking video image processing tool of claim 2 further comprising the step of setting an alarm flag if a human stays in a region of the video image longer than a preset period of time.

10. The human and object recognition and tracking video image processing tool of claim 2 further comprising the step of setting an alarm flag if an predetermined object from the reference image is detected as moving.

11. The human and object recognition and tracking video image processing tool of claim 2 further comprising the step of setting an alarm flag if a moving non-human object stays in a region of the video image longer than a preset period of time.

12. The human and object recognition and tracking video image processing tool of claim 2 in which each current image of the stream of color video images has 320 columns with 240 pixels in each column.

13. A method for recognizing objects within a field of view of a digital video camera comprising the steps of,
(a) obtaining a stream of color video images in the YUV color space;
(b) generating a reference image as a background model from past video images in the stream;
(c) determining a foreground image by comparing a current image from the stream of color video images to the reference image using a shadow filter;
(d) segmenting blobs in the foreground image;
(e) generating a feature vector for each blob;
(f) computing a vector difference between each feature vector to a codebook of code vectors, to determine a closest match code vector; and
(g) recognizing the blob as the closest match code vector if the vector difference is less than a match threshold.

14. The method of claim 13 wherein the shadow filter comprises a rule to exclude regions of the current image from the foreground image if all of the following conditions are true:
(a) a texture difference generated from a shadow filter neighbourhood of the current region and a shadow filter neighbourhood of the corresponding region of the reference image is zero,
(b) a color difference generated from a shadow filter neighbourhood of the current region and a shadow filter neighbourhood of the corresponding region of the reference image is less than a color difference threshold, and
(c) the current region is darker than the corresponding region of the reference image

15. The method of claim 13 further comprising filtering the foreground image for 1-Guassian noise.

16. The method of claim 13 in which the background model is a running average.

17. The method of claim 13 further comprising an intensity filter defining a rule to exclude regions of the current image from the foreground image if an intensity value of the region is within a first intensity threshold of a maximum intensity within a seven by seven pixel windows of the reference image corresponding to the regions of the current image.

18. The method of claim 13 in which each current image of the stream of color video images has 320 columns with 240 pixels in each column.
